(19) United States
(12) Patent Application Publication
(10) Pub. No.: US 2006/0080464 A1
(43) Pub. Date: Apr. 13, 2006

(54) System and method of utilizing a MAC address based unlocking key

(75) Inventor: Todd Gen Kozuki, San Diego, CA (US)

Correspondence Address: O'BANION & RITCHEY LLP/ SONY ELECTRONICS, INC., 400 CAPITOL MALL, SUITE 1550, SACRAMENTO, CA, 95814, US

(73) Assignees: SONY CORPORATION; SONY ELECTRONICS INC.

(21) Appl. No.: 10/941,257

(22) Filed: Sep. 14, 2004

(51) Int. Cl. G06F 15/16

(52) U.S. Cl. 709/245

(57) ABSTRACT

A system and method are described for activating programming downloaded to electronic devices. The method involves the generation of an encrypted (or encoded) activation key which is produced in response to the network address (i.e. media access control (MAC) address) of the electronic device to which the download is directed. Programming can only be activated within the electronic device upon a match being detected between the activation key and the network address of the electronic device. Typically, the programming would be downloaded from a web site, such as from a manufacturer of the electronic device, in exchange for receipt of a payment preferably executed as an online financial transaction. The system and method prevent the copying of downloaded programs for a given electronic device for use by other users.

### CROSS-REFERENCE TO RELATED APPLICATIONS

Not Applicable

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### NOTICE OF MATERIAL SUBJECT TO COPYRIGHT PROTECTION

A portion of the material in this patent document is subject to copyright protection under the copyright laws of the United States and of other countries. The owner of the copyright rights has no objection to the facsimile reproduction by anyone of the patent document or the patent disclosure, as it appears in the United States Patent and Trademark Office publicly available file or records, but otherwise reserves all copyright rights whatsoever. The copyright owner does not hereby waive any of its rights to have this patent document maintained in secrecy, including without limitation its rights pursuant to 37 C.F.R. § 1.14.

### BACKGROUND OF THE INVENTION

1. Field of the Invention

This invention pertains generally to program distribution, and more particularly to limiting distribution of programming to electronic devices based on their media access control addresses.

2. Description of Related Art

The popularity of various electronic devices has continued to increase, with sales in the gaming area, robotics and other portable electronics rapidly increasing. Many of these electronic devices are configured, or can be configured, for accepting updated programming that expands functionality, allows customization, and the like.

However, in a number of applications the cost of producing and distributing cartridges, memory cards, and so forth, for each application or enhancement can be cost prohibitive. It will be appreciated that distributing content in this manner requires creating an instruction manual, packaging the physical element, obtaining shelf space, tracking inventory, and so forth.

As a number of these electronic devices are configured with internal and/or removable memory and remote communications; new programming could be downloaded into the devices. However, programming distributed in this manner is typically so called “free-ware”, as no provisions exist for limiting programming distribution.

For example, consider the case of distributing program content for portable electronic robots. Although the upgrade can be communicated to the robot, such as over the Internet, there are no means available for limiting the distribution of that content. In some instances companies have required the use of program keys to activate programming and limit unwarranted copying. However, the users simply share the program key along with the program.

Accordingly, a need exists for providing improved protection for programs being distributed to robots and other electronic devices. The present invention fulfills that need as well as others and overcomes drawbacks in prior attempts at a solution.

### BRIEF SUMMARY OF THE INVENTION

A method and system are described for distributing copy protected program content to electronic devices having a network adapter. The program content being preferably downloaded through the network adapter of the device. A unique identifier within the electronic device, such as the network adapter address, is utilized in the creation of the unique activation key. Encryption, or any other convenient mechanism for encoding one data element within another data element may be utilized. The program content and unique activation key can only be utilized on the device having the proper device identifier (i.e. network address). Optionally, all or a portion of the downloaded program content may also be uniquely encrypted in response to the unique device identifier.

It has not been fully appreciated in the industry the extent to which additional revenue streams can be generated by providing optional programming for a number of electronic devices, without the requisite expenses associated with conventional packaging and distribution. The downloaded program content is considered to include executable instructions, parameters, data, and combinations thereof for being utilized by the computational element within the electronic device.

The invention relies on using a unique identifier, such as a network identifier an example of which is the media access control (MAC) address on the network adapter, of the electronic device within a process for generating a unique unlocking key associated with the program download. The unique unlocking key is then provided to the user to activate the program content. In this mode of distributing program content, the download can only be activated by a unique activation key which is valid for a specific device having the unique identifier (i.e. given network address such as a MAC address). Utilizing these mechanisms, program content can be sold for downloading from a web site, while preventing copying of that content by, or for, other users. In the following examples, the unique identifier is generally referred to as a MAC address, however, as mentioned other forms of unique identifier may be utilized.

By way of example, the following considers the example of downloading program content to a robot (i.e. Sony® AIBO ERS-7™), such as over an IEEE 802.11 (WiFi) wireless connection. In preparation for the download, the user enters identification information, performs a financial transaction, or both; after which they communicate (i.e. manual entry) the MAC address, such as printed on the robot (i.e. its belly) to a given network entity, typically a web site, which is configured for generating the download. The MAC address is used to generate the content, which is then downloaded to the robot. A unique activation key is then generated and provided to the user, such as sent by electronic mail (email) to the electronic device directly or to the user. Sending the unique activation key by email provides additional assurance that the proper user, typically the one identified or the one performing the financial transaction, receives the usable download.

The unique activation key operates in conjunction with the programming associated to verify the given MAC address of the given robot. In this way the program content cannot be illicitly shared amongst a group of users. Each user wanting the additional program content will of necessity download the content for their specific device, after typically identifying themselves as being entitled to such downloads or executing an associated payment transaction.

An embodiment of the invention can be generally described as a system for selectively activating downloaded program content on an electronic device, comprising: (a) a computer within an electronic device configured for utilizing downloaded program content; (b) a memory configured for operably coupling to the computer; (c) a network adapter coupled to the computer; (d) a unique ID associated with the electronic device that is accessible to the computer; (e) means for generating a program content download and a network address encrypted activation key for receipt over the network adapter; and (f) means for receiving the program content download and utilizing the activation key for activating the program content for use.

The unique ID in this embodiment preferably comprises a network address, preferably such as a media access control (MAC) address. The memory is selected from the group of memory types consisting essentially of embedded non-volatile memory, memory sticks, and memory modules. Memory may include resident memory, removable memory, or a combination thereof. The memory may be removed from the electronic device and program content downloaded into the memory from a separate memory reader/writer device, after which the program on the memory is activated when reattached to the electronic device.

An embodiment of the invention may also be described as a system for selectively activating downloaded program content on an electronic device, comprising: (a) a first computer within an electronic device which is configured for utilizing downloaded program content; (b) a memory coupled to the computer, the memory configured for retaining downloaded program content for access by the computer; (c) a network adapter coupled to the computer for communicating in a private network, the Internet, or a combination; (d) a unique ID configured for being accessed by the first computer; (e) programming executable on the first computer for activating a downloaded program in response to validating an activation key encrypted with the unique ID; (f) a second computer (i.e. web server) configured for processing download requests received over a network; and (g) programming executable on the second computer for, (g)(i) generating a download of program content through the computer server for receipt over the network adapter, (g)(ii) receiving a network address for the electronic device, (g)(iii) encrypting the network address into an activation key, (g)(iv) communicating the activation key for receipt within the electronic device or by a user of the electronic device for which the program content download is directed.

The second computer preferably comprises a web server configured to process user requests for program content downloads, although other network entities can be configured for controlling program content dissemination. To receive the content download the user may need to identify themselves, qualify in some manner, or execute some form of purchase (financial) transaction as a condition for granting a particular download request, or group of downloads.

An embodiment of the invention may also be described in terms of the electronic device as an apparatus for selectively activating downloaded program content, comprising: (a) a computer within an electronic device configured for utilizing downloaded program content; (b) memory coupled to the computer, the memory configured for retaining downloaded program content for access by the computer; (c) a network adapter coupled to the computer, the network adapter configured with a network address; and (d) programming executable on the computer for, (d)(i) establishing a network connection through which a download of program content can be received from a given network entity, (d)(ii) downloading the program content over a network coupled to the network adapter, (d)(iii) uploading of the network address to the given network entity; (d)(iv) storing an encrypted activation key which has been received, (d)(v) activating the downloaded program content in response to a determination that the encrypted activation key corresponds to the network address of the network adapter.

Embodiments of the present invention may also be generally described as a method of activating downloaded program content, comprising: (a) establishing a connection from an electronic device having a network adapter to a web site configured for downloading programming for the electronic device; (b) communicating a unique device identifier for the electronic device to the web site; (c) downloading program content from the web site to the electronic device; (d) generating a unique activation key within which is encrypted the unique device identifier; (e) communicating the activation key for use on the electronic device; and (f) activating the downloaded program content for execution within the electronic device in response to detecting a match between the unique activation key and the unique device identifier. The unique device identifier may be checked to determined if it is in the proper range of addresses for the given electronic device prior to downloading program content, generating a unique activation key, or both. The program content may also be encrypted prior to downloading, such as in response to the received unique device identifier.

It should be appreciated that the present invention provides a number of beneficial aspects, including but not limited to the following.

An aspect of the invention is to provide for the downloading of program content to network enabled devices.

Another aspect of the invention is to provide a mechanism which prevents a second device owner from copying program content purchased by a first device owner.

Another aspect of the invention is to provide a protection mechanism based on a unique device identifier which prevents copying.

Another aspect of the invention is to provide a unique activation key which is based on a network address, such as a MAC address.

Another aspect of the invention is to provide a unique activation key for activating device program content making it only operative for a specific device.

Another aspect of the invention provides for sending the unique activation key directly to the electronic device which received the program content download and is associated with the unique identifier provided to obtain the unique activation key.

A still further aspect of the invention allows the program content to be downloaded onto resident memory or removable memory.

Further aspects of the invention will be brought out in the following portions of the specification, wherein the detailed description is for the purpose of fully disclosing preferred embodiments of the invention without placing limitations thereon.

### BRIEF DESCRIPTION OF THE SEVERAL VIEWS OF THE DRAWING(S)

The invention will be more fully understood by reference to the following drawings which are for illustrative purposes only:

FIG. 1 is a block diagram of an electronic device configured for selectively activating downloaded programs according to an aspect of the present invention.

FIG. 2 is a flowchart of program execution according to an embodiment of the present invention, showing the utilization of an activation key.

### DETAILED DESCRIPTION OF THE INVENTION

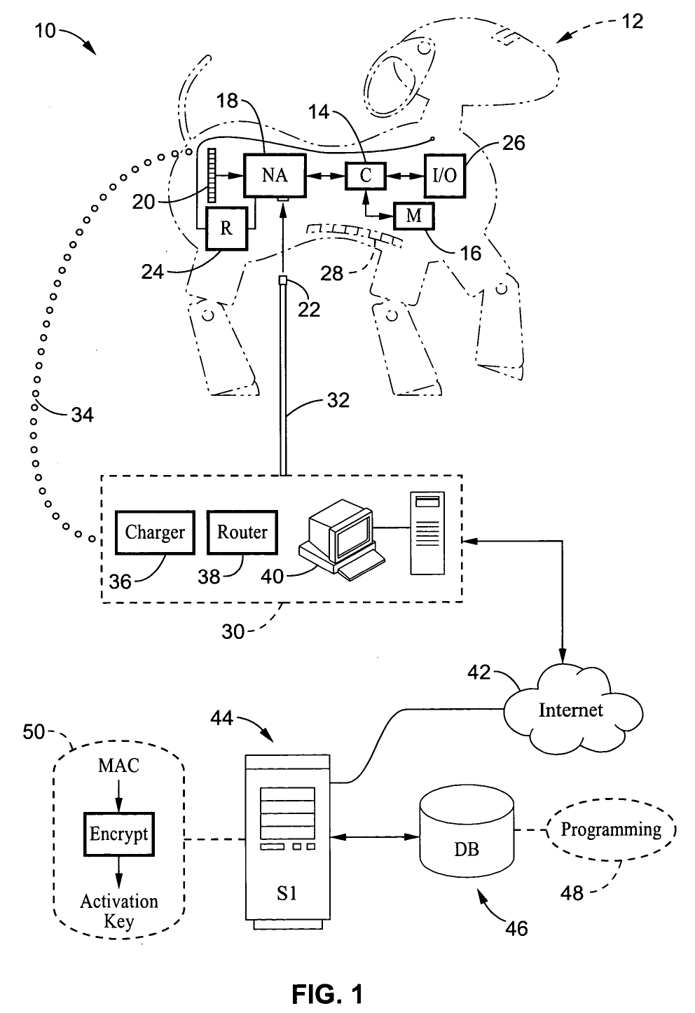

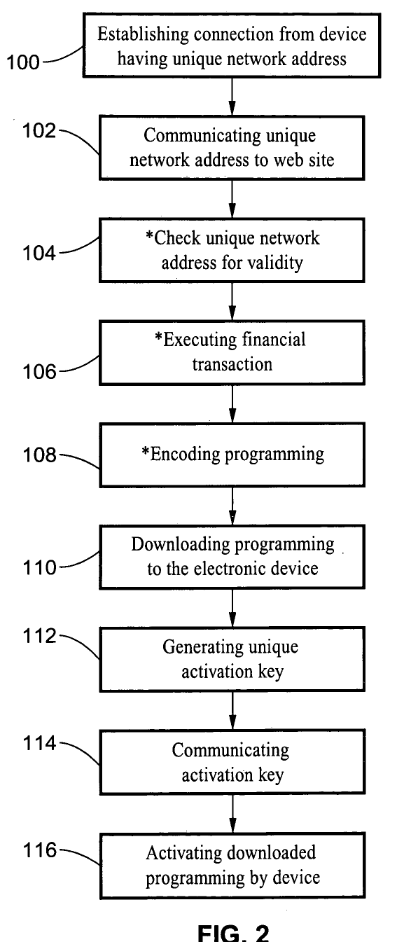

Referring more specifically to the drawings, for illustrative purposes the present invention is embodied in the apparatus generally shown in FIG. 1 through FIG. 2. It will be appreciated that the apparatus may vary as to configuration and as to details of the parts, and that the method may vary as to the specific steps and sequence, without departing from the basic concepts as disclosed herein.

FIG. 1 illustrates an example embodiment of a system 10 that utilizes downloadable program content according to the present invention. In the present embodiment, the electronic device comprises a robotic dog which has a computer which processes instructions for controlling the operations of the device. It will be appreciated, however, that the teachings of the present invention are applicable to robots in general, and also to other forms of electronic devices.

An electronic device 12 (i.e. AIBO™ dog by Sony® Corporation) is depicted within which computer 14 (i.e. microcontroller, microprocessor, digital signal processor (DSP), general purpose computer, or other circuitry configured for executing programmed instructions) and memory 16 is integrated along with a network access device 18 and a unique device identifier, such as readable (media access control) MAC address 20. By way of example and not limitation, other forms of unique identifier may be utilized, such as identifier chips, identifier programming into the non-volatile program memory and so forth.

The system and methods of the present invention are particularly well-suited for use on embedded control applications, such as exemplified by the AIBO robotic dog embodiment described in FIG. 1, although other applications can also benefit. A connector 22 on network access device 18 allows external connections to be established for connection to a network. Alternatively (or additionally), the system can be more preferably configured with wireless network connectivity 24 (i.e. radio-frequency communication link), for example according to an IEEE 802.11 standard (WiFi), or using the Bluetooth™ standard, or other wireless data standard or convention capable of communicating the programming media to the device.

It will be appreciated that a media access control (MAC) address is utilized to establish the physical connection of LAN workstations or device to a transmission medium (i.e. NIC circuit or card). The MAC address is a hardware address that uniquely identifies each node of a network and is also sometimes referred to as a data link control address (DLC address).

At least one input/output module 26 is typically coupled to computer 14, and in the present invention a number of sensors, actuators, and displays primarily comprise the inputs and outputs of the device.

A human readable label 28 is illustrated as being accessible on device 12 allowing the user to read and enter the unique identifier information as a condition of downloading the desired programming or data over the network connection.

A means 30 for connecting with a network, in particular the Internet, is depicted. By way of example a cable connection 32, or wireless connectivity 34, may be coupled directly to the internet, or connected through another device, such as a computer, a router, gateway or so forth. A charger 36 may be utilized as part of the network interfacing, or other mechanisms for establishing connectivity, such as an access point, gateway or router 38, or general purpose computer 40. The network connection can be established over the charging connection, such as a wired connection or inductive power coupling without departing from the teachings herein. The present invention also allows that the network connection can be provided by a separate connection specifically for establishing the download connection.

A preferred network configuration comprises utilizing a wireless LAN connection from the electronic device to an access point for the wireless LAN. The access point is connected to a private network which is preferably connected to the Internet by way of a broadband modem (i.e. cable modem, DSL, etc.). This configuration allows for local control as well as remote control and downloading. One of ordinary skill in the art will appreciate that the teachings of the present invention allows for the use of a number of different mechanisms for establishing network connectivity without departing from the present invention.

Connection is shown being established through the Internet 42 with a server 44 having at least one associated database 46 within which material, such as programming 48, for being downloaded is contained. The creation 50 of a MAC encrypted activation key is symbolized as occurring within server 44, as part of the download process for programming 48.

FIG. 2 depicts the method of controlling activation of programming according to the present invention. A connection is established as represented by block 100, the connection has a unique network address. Less preferably, a unique identifier other than a network address may be utilized. In block 102 a unique network address is communicated to a web site, or similar network based entity configured for supplying downloaded programming. Optionally, a check is performed as per block 104 on the validity of the network address before proceeding farther. Then in block 106 an optional financial transaction is executed, for example the registered user remits an amount for personal use of the downloaded programming on their device. An identification step may be additionally, or alternatively, utilized wherein a user is identified as being eligible to receive the download without payment, or to identify themselves in association with the financial transaction.

Additionally, the programming itself can be optionally encoded with the MAC address as depicted by block 108, to add another level of security to the download process. Alternatively, but less preferably, the download can be encrypted with the MAC address, instead of encoding the activation key.

In block 110 programming is downloaded to the electronic device, but it cannot be utilized without a correct activation key. An activation key is generated by the web site server, or other computer which participates or regulates program downloads. A unique activation key is generated in block 112 by utilizing the entered MAC address within an encryption algorithm.

In one form of encryption the MAC address may be utilized as an encryption key, or index, wherein a first activation key is then processed through the encryptor which utilizes the key or index. The encryptor algorithm outputs resultant data as a second activation key into which the first activation key has been modified in response to the MAC address. The roles of the MAC address and first activation key can be reversed in some cases as input to the encryption algorithm.

As the programming operable in the target electronic device utilizes a matching decryption algorithm and can read the MAC address for the device, it can recreate the first activation key from the second activation key. If the first activation key is valid, the device programming performs an activation of the new programming which has been received in the device.

Any of a number of forms of encryption may be utilized which allow encoding one or more pieces of data. It should be appreciated that alternatively, or additionally, that other information may be utilized within the activation key encryption process, such as unit codes, identifier for the programming to be activated and so forth. As a number of encryption and decryption mechanisms are well known in the art, details of how these algorithms operate need not be described herein.

In block 114 the activation key is communicated to the user, such as via downloading, or more preferably via an email so that a proper email address can be verified. The email may be communicated directly to an electronic device configured for communicating via email (i.e. receipt and/or sending such as through electronic mail post office programming). Once the activation key is received, the activation code is entered from the download, or in response to user entry, wherein an activation process is initiated on the electronic device for the downloaded programming as represented by block 116, after which the new programming may be utilized within the electronic device.

It will be noted that the activation code is typically configured for activating a single download, although it can alternatively be adapted for activating multiple downloads, or more preferably a group of selected downloads. For example, the activation key may contain information about which downloads are contained within the set of downloads to be activated. This can be accomplished for instance by providing fields of information for each download to be activated. In this way the user can select numerous downloads and need only perform a single activation operation. Alternatively, the length of the activation code can be extended to accompany the additional information necessary for enabling multiple downloads.

Although the description above contains many details, these should not be construed as limiting the scope of the invention but as merely providing illustrations of some of the presently preferred embodiments of this invention. Therefore, it will be appreciated that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

What is claimed is:

1. A system for selectively activating downloaded program content on an electronic device, comprising:
a computer within an electronic device configured for utilizing downloaded program content;
a memory configured for operably coupling to said computer;
a network adapter coupled to said computer;
a unique ID associated with said electronic device that is accessible to said computer;
means for generating a program content download and a network address encrypted activation key for receipt over said network adapter; and
means for receiving said program content download and utilizing said activation key for activating said program content for use.

2. A system as recited in claim 1, wherein said unique ID comprises a network address.

3. A system as recited in claim 2, wherein said network address comprises a media access control (MAC) address.

4. A system as recited in claim 1, wherein said memory is selected from the group of memory types consisting essentially of embedded non-volatile memory, memory sticks, and memory modules.

5. A system as recited in claim 1, wherein said memory may be removed from said electronic device and program content downloaded into said memory from a separate memory reader/writer device.

6. A system as recited in claim 1, wherein said means for receiving program content is configured for interacting with a given network entity from which program content is downloaded.

7. A system as recited in claim 1, wherein utilizing said activation key for activating said program content for use comprises activating the downloaded program content for use only if the activation key corresponds with the network address of the electronic device.

8. A system as recited in claim 1, wherein said encrypted activation key is received by said electronic device within an electronic mail message over said network.

9. A system as recited in claim 1, wherein said encrypted activation key is received by a user and entered manually upon a user interface for said electronic device.

10. A system for selectively activating downloaded program content on an electronic device, comprising:
a first computer within an electronic device which is configured for utilizing downloaded program content;
a memory coupled to said computer, said memory configured for retaining downloaded program content for access by said computer;
a network adapter coupled to said computer for communicating in a private network, the Internet, or a combination;
a unique ID configured for being accessed by said first computer;
programming executable on said first computer for activating a downloaded program in response to validating an activation key encrypted with said unique ID;
a second computer configured for processing download requests received over a network; and
programming executable on said second computer for,
generating a download of program content for receipt over said network adapter,
receiving a network address for said electronic device,
encrypting said network address into an activation key,
communicating said activation key for receipt within the electronic device or by a user of the electronic device for which the program content download is directed.

11. A system as recited in claim 10, wherein said unique ID comprises a network address associated with said network adapter.

12. A system as recited in claim 11, wherein said network address comprises a media access control (MAC) address.

13. A system as recited in claim 10, wherein said second computer comprises a web server configured to process user requests for program content downloads.

14. A system as recited in claim 10, further comprising programming for execution on said second computer for processing user identification, a financial transaction, or combination, as a condition for granting each said download request.

15. A system as recited in claim 10, wherein said programming for said first computer is configured to activate downloaded program content for use only if the activation key corresponds with the network address of the electronic device.

16. A system as recited in claim 10, wherein said memory may be removed from said electronic device and program content, activation keys, or a combination of the two downloaded into said memory from a separate memory reader/writer device.

17. A system as recited in claim 16, wherein said first computer is configured for activating said program content from said memory only if the encryption within said activation key corresponds to said unique ID.

18. A system as recited in claim 10, wherein said encrypted activation key is received by said electronic device within an electronic mail message over said network.

19. A system as recited in claim 10, wherein said encrypted activation key is received by a user and entered manually upon a user interface for said electronic device.

20. An apparatus for selectively activating downloaded program content, comprising:
a computer within an electronic device configured for utilizing downloaded program content;
memory coupled to said computer, said memory configured for retaining downloaded program content for access by said computer;
a network adapter coupled to said computer, said network adapter configured with a network address; and
programming executable on said computer for,
establishing a network connection through which a download of program content can be received from a given network entity,
downloading said program content over a network coupled to said network adapter,
uploading of said network address to the given network entity,
storing an encrypted activation key which has been received,
activating said downloaded program content in response to a determination that the encrypted activation key corresponds to the network address of the network adapter.

21. An apparatus as recited in claim 20, wherein said network address comprises a media access control (MAC) address.

22. An apparatus as recited in claim 20, wherein said memory is selected from the group of memory types consisting essentially of embedded non-volatile memory, memory sticks, and memory modules.

23. An apparatus as recited in claim 20, wherein said given network entity comprises a web site.

24. An apparatus as recited in claim 23, further comprising executing an identification process, payment transaction, or combination with said web site as a condition of downloading said program content.

25. An apparatus as recited in claim 20, wherein said network address is printed on an accessible portion of said electronic device.

26. An apparatus as recited in claim 20, wherein said network address is manually entered by a user during interaction with the given network entity.

27. An apparatus as recited in claim 20, wherein said network connection comprises a wireless network connection.

28. An apparatus as recited in claim 20, wherein said memory may be removed from said electronic device and program content downloaded into said memory from a separate memory reader/writer device.

29. An apparatus as recited in claim 20, wherein said encrypted activation key is received by said electronic device within an electronic mail message over said network.

30. An apparatus as recited in claim 20, wherein said encrypted activation key is received by a user and entered manually upon a user interface for said electronic device.

31. A method of activating downloaded program content, comprising:
(a) establishing a connection from an electronic device having a network adapter to a web site configured for downloading programming for said electronic device;
(b) communicating a unique device identifier for said electronic device to said web site;
(c) downloading program content from said web site to said electronic device;
(d) generating a unique activation key within which is encrypted said unique device identifier;
(e) communicating said activation key for said electronic device; and
(f) activating said downloaded program content for execution within said electronic device in response to detecting a match between unique said activation key and said unique device identifier.

32. A method as recited in claim 31, wherein said unique device identifier comprises a network address.

33. A method as recited in claim 31, wherein said network address comprises a media access control (MAC) address.

34. A method as recited in claim 31, further comprising checking that said unique device identifier is in the proper range of addresses for the given electronic device prior to downloading program content, generating a unique activation key, or both.

35. A method as recited in claim 31, further comprising encoding the program content prior to downloading in response to the received unique device identifier.

36. A method as recited in claim 31, further comprising performing a financial transaction prior to receiving said program content and said unique activation key.

37. A method as recited in claim 31, wherein communicating said unique activation key is performed by sending the unique activation key via email.
